(19) United States
(12) Patent Application Publication
(10) Pub. No.: US 2021/0012254 A1
(43) Pub. Date: Jan. 14, 2021

(54) SAFETY RISK, AUDITING, AND COMPLIANCE SYSTEM AND PROCESS

(71) Applicant: Statute 13, LLC, Lake Mary, FL (US)

(72) Inventors: Marissa Brooks-Torman Campbell, Lake Mary, FL (US); Matthew Munro Parman, Gig Harbor, WA (US)

(73) Assignee: Statute13, LLC, Lake Mary, FL (US)

(21) Appl. No.: 16/927,964

(22) Filed: Jul. 13, 2020

Related U.S. Application Data
(60) Provisional application No. 62/873,083, filed on Jul. 11, 2019.

(51) Int. Cl. G06Q 10/06; G06Q 30/00; G06Q 50/26; G06Q 10/10; G06F 16/28

(52) U.S. Cl. CPC G06Q 10/0635; G06Q 30/0185; G06F 16/284; G06Q 10/1053; G06Q 50/265

(57) ABSTRACT

A safety compliance and auditing process is provided. The process includes providing a computer-generated program accessible by a computer device having a processer, a user interface visual display for hosting a dashboard, a wireless communication module, and a storage unit. The program is configured to perform an audit process through the steps of (a) requesting and receiving compliance information from a plurality of safety compliance sources; (b) establishing compliance boundaries corresponding to a specific job and location; (c) requesting background information associated to an individual from a plurality of background information sources available through the internet connection; (d) comparing the background information to the compliance boundaries to determine if the background information surpasses a boundary; (e) generating an alert if the background information surpasses a boundary; (f) generating a risk score; and (g) initiating a sampling frequency to trigger a repeat audit corresponding to the risk score.

### CROSS REFERENCE TO RELATED APPLICATION

This application claims priority to U.S. Provisional Application No. 62/873,083 filed Jul. 11, 2019, which is hereby incorporated herein by reference in its entirety.

### TECHNICAL FIELD

The present disclosure relates generally to a computer implemented process in the field of safety, compliance and risk assessment and various systems for improved aggregation, storage, and risk evaluation of data.

### DESCRIPTION OF RELATED ART

Human capital is the largest single expense for most organizations and therefore hiring the right employees for a company is one of, if not the most, important process for the company. The hiring of the wrong employee is detrimental to any company. Poorly performing employees negative impact the company through shoddy work, damage the culture, lose customers, fail to innovate, tarnish the company's reputation, generate safety risks, add expense and can even endanger vulnerable populations in areas such as health care, elder care and education, just to name a few.

Companies struggle with monitoring and management of data as it relates to safety and compliance issues. Often these issues are nuanced and unique to different categories resulting in varying degrees of risk and information required to make an effective decision. Companies struggle with aggregating, analyzing, auditing, and relying on certain information that could be critical to compliance with certain rules and regulations.

For example, the hiring of the right employees for a company is one of, if not the most, important processes for the company. The hiring of the wrong employee can have negative impacts throughout the company. Bad performing employees can negatively impact the company through shoddy work, negatively impact the other employees they are around, their customers, other humans they interact with including children, reputation of the organizations and could cost the company a lot of unnecessary expenses. However, the hiring process is not an easy proposition. Successful companies do their due diligence of their prospective employees. Due diligence is a significant drain on a company's resources and an organization challenge. Further, despite following all or most of the proper precautionary measures before hiring an employee, the company can still end up hiring a “bad apple.” The due diligence process is not a forecast. Rather, it is risk evaluation and management. As more and more background information is made available, there is a need for improved and better systems and process for managing and evaluating the background data in order to better assess and weigh prospective, and even existing, employees' future performance.

Companies, particularly those that utilize contingent staffing, have a difficult time auditing background checks for the employees. Contingent staff are temporary workers who supplement a company's workforce. They may be hired through a third-party staffing agency, or “vendor”, and usually work under a contract for a fixed period of time or for a specific project. Currently, over 16.5 million Americans are engaged in contingent work. Further, certain governmental entities, such as the Department of Labor (“DOL”) and Occupational Safety and Health Administration (“OSHA”), require that employers follow certain regulations and procedures in the hiring of their employees, namely the implementation of effective background checks and drug screens of applicants in order to ensure that individuals with a violent history are carefully screened. Such regulations create a need for an effective system of background checks and organization among prospective employees.

In the present economy following the coronavirus pandemic, companies are expected to utilize more contingent staffing. Further, companies will need to implement certain back-to-work policies in order to comply with government safety and health regulations with regards to infectious disease. These government regulations and policies are designed to stem infectious disease transmission. Some of these regulations include temperature checks, required use of personal protective equipment (“PPE”), such as masks or face shields, health and wellness questionnaires, cleanliness and disinfectant procedures, and contact tracing should any infection be reported. Companies opening during the pandemic or following the pandemic will need to be able to efficiently track, record, and assess any deficiencies in the infectious disease safety policies for the health and safety of their workforce and patrons.

### SUMMARY

The present disclosure provides for a system and process for identifying, recognizing and reacting to risk in the field of safety, compliance and risk mitigation by gathering data from a plurality of sources, utilizing a mechanism to process the data and generate a product through a cloud-based service, displaying the product and the processed data in a dashboard, and automatically using the product and the processed data to trigger alerts or guides when thresholds associated with an increased risk, non-compliance or health threat have been identified, thereby allowing employers and/or users of the system and process and workers to engage in employment while boosting community safety based on amalgamated and audited data, worker health and legal verifications. The system and process utilize a computer generated program provided on a computer system and network to retrieve data through an internet connection and establishing rules and boundary conditions to track and gauge compliance with those rules and conditions across a plurality of varying job types, locations, and rules while automating alerts and compliance scores. Moreover, the system can be updated based on the compliance score results that correspond to modifying risk factors.

The present disclosure provides for a system and process for gathering data from various disparate sources, processing the data, displaying the data in a dashboard, and setting alerts or guides for a user to perform different actions based on the information collected. The system is designed with an algorithm that is programmed to, either automatically or by request, scrape the web for certain information and data. The information is transferred to cloud storage through the process of cloud computing. The information is then stored in the cloud storage through a web service known as relational database service. The algorithm then pulls certain information from the relational database service and places the information on a dashboard. The information is displayed on the dashboard for a user to navigate and create a report based on the data. The algorithm is programmed with internal alerts and notifications for the user based on the different collected information.

The present disclosure further provides for a system and process that provides effective and accurate employee information accessible in a dashboard for companies and/or users to be able to monitor. The system includes an auditing tool and automated dashboard that allows companies to accurately and efficiently aggregate and audit data related to background checks and drug screens of employees. The system houses and/or accesses stored data related to the employees' backgrounds, connects to traditional providers of background checks, and allows companies to compare the results of their search to those of the traditional providers' search results. Those results can then be aggregated and processed to determine a corresponding risk score based on the background data collected as it compares to the risk of the particular job description.

The present disclosure further provides for a system and process that identifies an employee or potential employee for a company and assesses the compliance score and potential risk of the employee. The system includes an identifier tool that connects to background check and drug screen sources, including that of the United States government or other governmental entities. The identifier tool pulls and obtains certain personal information of the employee or potential employee such as drug screens, background checks, and other relevant compliance and/or risk assessment information. Those results can then be aggregated and processed to determine a corresponding risk score to the company based on the background information as it compares to the risk of the job. The system can then be repeated at a pre-determined cadence rate to determine the continued adherence to certain compliance regulations.

The present disclosure further provides for a system and process for identifying compliance and adherence to infectious disease policies and regulations. When local, regional, state, and/or federal laws and regulations are implemented in order to stem the spread of an infectious disease, companies are required to comply with these regulations in order to maintain operations. These regulations can include temperature checks, required use of personal protective equipment (“PPE”), such as masks or face shields, health and wellness questionnaires, cleanliness and disinfectant procedures, and contact tracing should any infection be reported. This system provides for digital forms available through a computer interface or mobile phone interface that employees and/or patrons can complete. The information from the digital forms are uploaded to a consistently updated dashboard that alerts the company regarding compliance with the government regulations. In a further example, the system generates alerts for when employees or patrons are allowed to return on premise.

The present disclosure further provides for a token and badging system and process whereby employees are able to take the results from their own background check and credentialing as a portable identification tool. Employees can utilize the token and badging system by providing a background check, Employment Eligibly Verification Form 1-9, and photograph. When a requesting party seeks the information in the employee's background check, the employee can submit the token to the requesting party in real-time through any internet connected device. In an example, the token can be read by the scanning of a QR code or other unique identifier.

The present disclosure further provides for a tumbler model that measures compliance monitoring across various jobs with similar risk assessment. A tumbler is determined by set of risk factors that are associated with a certain job description. Individual employees with jobs that have a similar risk assessment are placed in the same tumbler. An algorithm randomly selects an individual employee from the tumbler to test and determine if that employee has undergone the required checks for compliance monitoring, such as background checks and drug screens. The test also determines whether that individual is up to date on all of the required checks in order to be qualified for the job. The frequency of the random testing is directly related to the risk associated with the tumbler. Once the individual is tested for compliance, the individual is placed back in the tumbler and the cycle repeats for a given period of time.

For purposes of summarizing the disclosure, certain aspects, advantages, and novel features of the disclosure have been described herein. It is to be understood that not necessarily all such advantages may be achieved in accordance with any one particular embodiment of the disclosure. Thus, the disclosure may be embodied or carried out in a manner that achieves or optimizes one advantage or group of advantages as taught herein without necessarily achieving other advantages as may be taught or suggested herein. The features of the disclosure which are believed to be novel are particularly pointed out and distinctly claimed in the concluding portion of the specification. These and other features, aspects, and advantages of the present disclosure will become better understood with reference to the following drawings and detailed description.

### BRIEF DESCRIPTION OF THE DRAWINGS

The figures which accompany the written portion of this specification illustrate systems and processes for the present disclosure configured, constructed and operative according to the teachings of the present disclosure.

FIG. 1 illustrates a flow diagram of an auditing process whereby a third-party staffing agency, or “vendor”, provides information on an applicant that is assessed for compliance and risk by an auditing tool according the present disclosure.

FIG. 2 illustrates a flow diagram of an auditing process whereby an auditing tool screens an applicant based on available information from a plurality of screening sources and relays the information to a third-party staffing agency.

FIG. 3 illustrates a flow diagram of a risk assessment and auditing process based on job title.

FIG. 4 illustrates a flow diagram of an infectious disease compliance process whereby a worker populates information to a digital wellness form and the information and compliance score is displayed on a dashboard.

FIG. 5 illustrates a flow diagram of an infectious disease compliance process whereby a patron of a workplace populates information to a digital wellness form and the information and compliance score is displayed on a dashboard.

FIG. 6 illustrates a flow diagram of an infectious disease compliance process whereby a company populates information to a digital wellness form and the information and compliance score is displayed on a dashboard.

FIG. 7 illustrates a flow diagram of an indexing and alert tool that organizes and displays information related to rental insurance certificates and generates alerts and compliance scores related to the certificates.

FIG. 8 illustrates a flow diagram of a token and badge system whereby a worker completes a predetermined number of checks and screens and receives a unique identification badge and number.

FIG. 9 illustrates a schematic view of a client-user interface employment compliance monitoring dashboard which aggregates and displays employee and staffing compliance and risk assessments.

FIGS. 10-15 illustrate schematic views of various screenshots of a client-user interface employment compliance monitoring dashboard of FIG. 9.

FIGS. 16A and 16B illustrate schematic views of a client user interface rental insurance monitoring, compliance and alert dashboard.

FIGS. 17A and 17B illustrate schematic views of a client user interface infectious disease monitoring dashboard which aggregates and displays compliance with infectious disease regulations and requirements.

FIG. 18 illustrates a flow diagram of an auditing program for monitoring compliance and risk assessment and displays the results on a visual dashboard to an employer or consumer.

FIG. 19 illustrates a flow diagram of a token and badging system whereby a user can receive a user-specific credentialing for a portable identification tool.

FIG. 20 illustrates a flow diagram of a tumbler model that measures compliance across various jobs with risk assessments.

The various embodiments of the present disclosure will hereinafter be described in conjunction with the appended drawings, wherein like designations denote like elements.

### DETAILED DESCRIPTION

The present disclosure provides for a system and process for gathering data from a plurality of sources, processing the data using a computer based program hosted on a network and communicating through a cloud-based service, displaying the processed data in a dashboard, and setting alerts or guides when preset thresholds are have been achieved associated with increased risk or non-compliance. The system and process allow for more or more users to perform actions based on the processed information. The system is designed with an algorithm that is programmed to, either automatically or by request, scrape desired content available through the web for certain information data associated with safety and compliance. The information is transferred to cloud storage through the process of cloud computing. The information is then stored in the cloud storage through a web service known as relational database service. The algorithm then pulls certain information from the relational database service and places the processed information on a dashboard. Compliance information associated with a certain task or event is also gathered and a comparison is made whether the information obtained and processed exceeds limits set forth in the compliance information. The system and process can then generate a compliance packet and score identifying the desired information which then can generate an alert that noncompliant activity has occurred. The processed information is displayed on the dashboard for a user to navigate and a report is generated directed to the compliance score based on the processed data and compliance information comparison. The system is configured with internal alerts and notifications associated with a predetermined frequency for the user based on different information that is collected.

In an example, the system and process allow for users to perform actions based on the processed and generated information that could not have been made without access to such process and generated information. The system is configured with a series of process steps that is initiated when a request is made from an employer or through an automated program for specific information regarding a specific employee or plurality of employees. In another example, the information is directed to an entire group of employees with similar or identical job codes, i.e., custodians, mechanics, cooks, accountants, etc. The system is also configured with a series of steps that are programmed to, either automatically or by request, scrape desired content available through the web for certain risk factor and compliance data associated with safety and compliance. The system is also designed with a process that automatically develops a specific dataset that is unique and unavailable to any other entity because the output is derived from specific employee information in addition to the specific gathered information.

In each instance, the information can be gathered and transmitted via on-premises-to-cloud and cloud-to-cloud migration. The information then passes through a firewall and populates a relational database. The relational database is accessed via a dashboard accessible on a computer or device having a user interface and a processer configured for access by a user. The dashboard further includes a report generating step to allow compliance tracking on an enterprise level.

In an example, a user triggers the process to initiate via a dashboard accessed through a computer, tablet, wireless device or dedicated device. Initiating the process sends a request via an application programming interface to other organizations/resources to obtain information related to specific employees' compliance documentation such as, but not limited to, drug screen results, background check results, and 19 compliance, among others. The background information is then returned and combined with previously obtained information related to that specific employee's history, or related to the specific project, location, or job type for broader compliance scoring. The system pulls certain information from the relational database which passes back through a firewall and is combined with the existing information for that particular category.

The present disclosure further relates to a background check compliance system and process. The system and process include an auditing tool and an automated dashboard that allows a user to accurately and efficiently aggregate and audit background check data for one or more existing and potential employees to generate risk assessments and scores associated with that individual for a specific job. A report associated with the assessment score is then generated. These reports can then be aggregated periodically on a local or institution level for scoring across a corporation or for a particular location or project. The system and process further obtain existing information and compliance standards and then generates new compliance boundaries associated with a specific job title based on historical data or inputs from the employer. For example, for a specific job, certain activity and information may be determined a high risk based on existing data, like having an intoxicated driving violation on a criminal record would be high risk for a bus or truck driving job but low risk for a cook or janitorial position. Compliance information related to a specific job would be provided and set forth boundary conditions that if surpassed, would result in an alert. The system and process can be configured to automatically retrieve this data at predetermined intervals, (i.e., once a year, twice a year, quarterly, and/or daily). The compliance data which generates ongoing risk information is also updated. Moreover, the process can be configured to be a gate keeper, wherein the company's human resource system will not allow employee processing without a passing score from the background compliance system.

The background check system and process of the present disclosure analyzes, extracts, houses and accesses data related to an individual's background check data obtained through the web from a plurality of existing background check services. The system and process are configured to communicate remotely and automatically with the existing background check providers to collect background check data from all of the sources, and then compare the results against existing records. The collected data provides for a more accurate and robust picture of the individual's specific background thus allows for a more accurate determination for eligibility of employment for a specific job. Previously, a user or employer would have to select one or more providers and submit background checks in isolation from the information of the other providers. Often, each service provider returns differing information and thus a complete picture is often not obtainable. Moreover, it would too costly and burdensome to check data from every source available, enter the data into an accessible database for comparison and determine if an alert is required. This is would be especially burdensome on a large scale for employers or co-employers with thousands of workers across the country. Updating the database for existing employees across all sources of information would be even more impossible if required on a periodic basis. In a further example, machine learning is implemented into the system and process to gauge ongoing risk scores and modify data tracking frequency and modifying hiring choices by changing the preset compliance boundaries.

The present disclosure further provides for a system and process that identifies an employee or potential employee and assesses the employee's compliance with government regulations and determines a risk score associated with a specific job. The system and process include an identifier tool that connects to a plurality of background check and drug screening sources including the United States government resources or other governmental entity like local and state level resources. The identifier tool obtains relevant employment information of the employee such as drug screens, background checks, and/or other relevant compliance and risk assessment information. Those results are then be aggregated and processed to determine a corresponding risk score based on the background information as it compares to the risk of the job. Thus, the risk score is compared to boundary conditions that are preset or obtained for a specific job that identifies risk if certain background-related conditions are met. The system can then be repeated at a pre-determined period of time to track continued adherence to the governmental compliance regulations.

Currently, it is difficult for companies to obtain a full picture of an individual's background information and the risk associated with any particular aspect of that information as it relates to the intended job. Moreover, information related to varying degrees of risk is available but not compiled or aggregated from various agencies and government resources. Further, compliance with government regulations varies from state to state. A multinational corporation with facilities, offices, and employees in different states may have different compliance requirements. Further, as regulations and compliance data changes, no system exists that automates, alerts, and incorporates those specific changes. This creates a massive burden on any organization to merely keep up or track. Accordingly, mistakes are often made and significant inefficiencies exist causing financial losses and more.

In an example, an employee can operate a computer program, hosted on a computer network that allows centralized monitoring, aggregating, comparing, and updating across varying conditions. The system and process of the present disclosure inputs various locations and jobs existing in a company. The program then categorizes each location and corresponding job types with corresponding compliance regulations associated with each. The program identifies a resource website and service provider to access both compliance requirements, compliance data, and background information. The system is configured to periodically, on a predetermined basis or sampling frequency, submit requests for this information from the plurality of resources. Each employee or potential employee is generated a specific data packet associated with that individuals' credentials and/or bibliographical data. The system and process then provide the data from the data packet to the various resources to request and obtain the compliance and background information. The data is then compared to existing compliance regulations and boundary conditions for a specific job.

The data is processed through cloud computing and generates an updated data packet specific to that individual and whether or not their information is acceptable within the preset boundary conditions for that specific job at that specific location. A risk score is then established, for example, low risk, no risk, high risk. If the result is high risk, an alert is generated and associated with that individual.

In a further example, the system provides a gate to prevent further employment processing for that position at that location until a risk alert is removed. An alert can be removed through evidence of compliance or proof that the analysis was mistaken. Moreover, a machine-learning process can be implemented that can trigger the system to modify its sampling frequency resulting from consistent low risk scores across a given time period. For example, for a custodial position at a given location with low risk of theft, it may be determined that the employees with non-violent criminal backgrounds are low risk for that position, however, a failed drug screening increases that risk. A boundary can be set to trigger a warning and then an alert when one screening is missed or failed and then a termination alert when a second screening is missed or failed. For the criminal record background check, the system may modify its sampling frequency to once every year rather than two or three times a year. However, the system may increase it's sampling on drug screening information to monthly rather than quarterly as identifying the risk factor associated with failed drug screening. The system can also track location specific information to provide compliance data and statistics for a specific site or project. The company can then gauge compliance and risk factors across different jobs and locations.

In another example, a dashboard having a plurality of auditing tools, specific to a company defines a user interface that displays compliance scores, risk scores, and company-wide data associated with desired feedback. A user—often a compliance manager or the like, can instruct the system and process to acquire data for specific locations and projects to determine risk and compliance scores through the dashboard tools. The dashboard can be displayed on a computer screen or a tablet that remotely and wirelessly communicates with the cloud computing source to acquire the updated data packets associated with specific jobs, risk scores, and compliance scores for given locations. The dashboard can further manage and store alerts that require reconciling by an authorized party. The process is further operable for generating reports on a predetermined time period or basis—i.e., daily, weekly, monthly, quarterly, etc. Thus, the management and control of background information and compliance boundaries are significantly improved configured to provide more efficient, automated, and cost-effective workforce management and compliance.

The present disclosure further provides for a system and process for identifying compliance and adherence to infectious disease policies and regulations. This is especially important in the era of Covid-19 contact tracing and health screening to reduce the risk of spread. When local, regional, state, and/or federal laws and regulations are implemented in order to stem the spread of an infectious disease, companies are required to comply with these regulations in order to maintain operations which include health screening, contact tracing and tracking. On an enterprise level, the requirements for one job in a certain location may be different from another job in a different location. The ability to manage, track, and automate the requirements in a centralized and remote way is critical to effective compliance.

Example regulations can include daily temperature checks, health and wellness screening, use of personal protective equipment (“PPE”), such as masks or face shields, cleanliness and disinfectant procedures, and contact tracing should any infection be reported. The present disclosure provides for digital forms available through a computer interface or mobile device interface that employees and/or patrons can complete. In an example, a dedicated tablet having wireless communication module configured for transmitting and storing data is provided, having a touch screen and user interface for imputing information. The information from the digital forms is captured and imported into a database which is then uploaded to an updated dashboard accessible remotely with proper access. Alerts are generated regarding compliance with the government regulations that include individual compliance and specific projector location compliance. Local requirements and compliance rules are also obtained and uploaded with the specific individual to ensure compliance. In a further example, the system and process generate alerts for when certain employees or patrons are allowed to return on premise. Moreover, alerts can be generated to indicate that substitute employment is required for a specific project or location. Further, data related to PPE compliance and inventory is provided that allows for automated and real-time ordering, restocking, and tracking.

The system and process can further allow for an employee to remotely access and submit the health screening through a website or mobile application. Compliance with the screening can then automatically be associated with that individuals' badge to be scanned upon entrance into a facility. In a further example, a digital thermometer is provided for touchless temperature checks. The thermometer reading can be manually entered for that individual or communicated through a communication module like BLUETOOTH or WIFI to the health screening digital form. Issuance of PPE for that individual can further be tracked through the digital form to ensure compliance with the specific rules. Moreover, compliance with cleaning and disinfecting a location can further be tracked through inputs from management for a specific job or location.

In an example, a company may have a manufacturing facility with 1000+ workers arriving daily to a facility at location A in one state. The company may also have a construction project ongoing in a different state at location B. Based on several factors such as location, ongoing contagion risk for that location, local and state PPE and social distancing requirements, previous outbreaks for a similar facility, expected daily exposure, time spent in a confined space, and volume of people per square foot, daily health screening is required prior to entry into a facility which includes a temperature reading and issuance of PPE like masks and gloves. The construction project may have more relaxed rules resulting from location, density of workers, exposure to outdoors rather than confined spaces, and reduced PPE requirements. Through digital and remote tracking of the health screening data, cleaning compliance data, and PPE distribution for each location, a company can more effectively monitor compliance, track risk, monitor alerts such as if an outbreak occurs that requires alternative employment arrangements, shutdowns, and large-scale cleaning or modification of work conditions (i.e., implement plastic barriers or increase distancing). When PPE equipment onsite falls below a certain level, an automated alert can be generated to a central corporate manager along with a local manager, and automatically trigger an order of additional supplies to be made. Moreover, if an employee fails the health screening, that individual can be instructed to obtain a test and provide the results of the test to be incorporated into the system which flags a return date before returning. In an example, the return date is set to 1 week or 2 weeks after a failed screening occurs. This further makes informing that individuals colleagues and contact tracing which can automatically alert those individuals through wireless communication—i.e., a text message, an email, or both that they may have had exposure risk and may consider getting a test or more closely monitor symptoms.

The present disclosure further provides for a system and process for utilizing a computer program tool hosted on a computer-based program accessible through a dashboard and user interface. The process is characterized by a submitting a request, at a predetermined frequency for background checks of existing employees, and then automatically reports those results to authorized requesting user or users. Risk levels for each employee job code (for example, based off of OSHA and DOL codes) is assessed by the system based on type of job, and risk of a particular injury whether physical or financial such as physical harm, financial harm, property damage, and/or crime. This classification dictates the cadence and is automatically updated as new information related to risk is made available or learned through a machine learning module implemented into the program, which is monitored by a web scraper (automated).

The present disclosure still further provides for a system and process of a token and badging system by which employees are able to take current results of their own background check and credentialing with them as portable identification. This effort is empowered by the worker initially submitting to a background check and Employment Eligibly Verification Form 1-9, and submitting a photograph. The information is then rechecked at a predetermined cadence as dictated by a user. When a requesting party is requests to retrieve the information, it can be reviewed, in real-time, with any internet connected device, particularly if it is capable of scanning a QR code or other unique identifier and is in control of the individual employee.

In a growing number of industries, companies are required to comply with certain local, state, and federal government regulations. Such compliance with the regulations can be a tedious and complex process, especially in a large corporation with many employees. Further complicating matters, many companies utilize “contract” or “temporary” workers that are hired from third-party staffing agencies. The temporary staff must still comply with government regulations even if they are only temporarily hired by the company. The risk associated with these temporary employees is greatly magnified due to the company's lack of oversight and screening of these workers. Rather, the hiring company must rely on the representations of third-party staffing agencies.

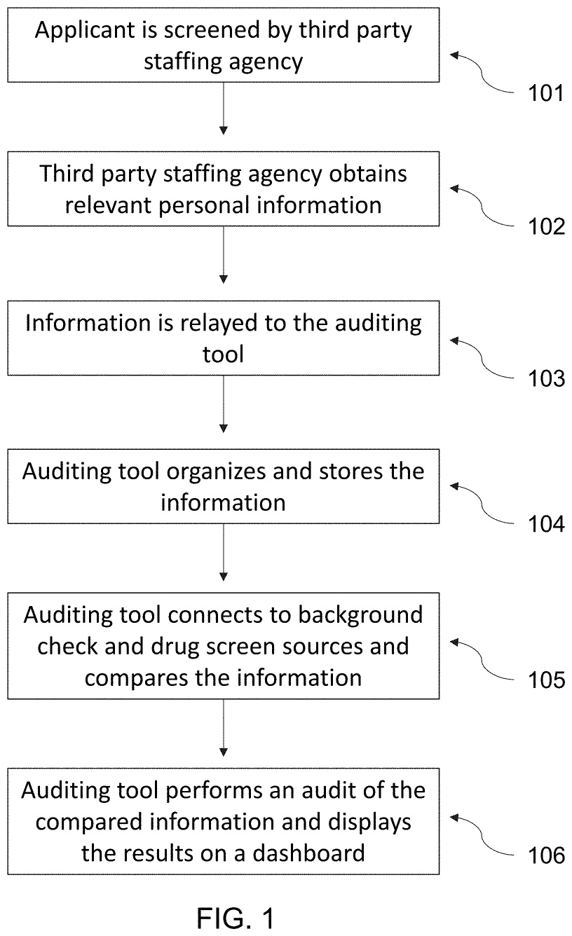

With reference now to the drawings, and particularly, FIGS. 1 through 8 illustrate example flow diagrams for processes of compliance monitoring and risk assessment for companies and their employees. Organizations are expected to know and adhere to various industry, business, and government regulations. An auditing tool of the present disclosure can automate, enhance and ease a hiring company's burden of monitoring compliance with the industry regulations, business parameters and government regulations and mitigates the risk associated with noncompliance and potential workplace misconduct of a potential or current employee.

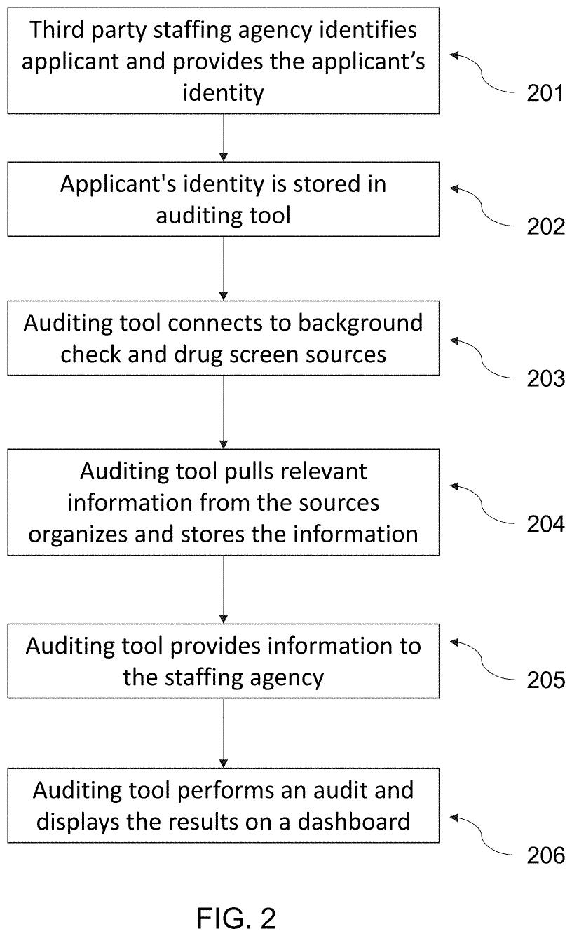

Referring specifically to FIGS. 1 and 2, a third-party staffing agency, or “vendor”, is required to gather and verify a multitude of documents from many sources to determine whether an applicant is legally and contractually compliant for a role at a hiring company, as shown in stage 101. For example, the vendor must verify employee eligibility like social security number or working visa, that the eligibility is current and valid, and for certain positions, if licenses have been obtained and maintained, like commercial driving licenses, etc. In stage 102, the staffing agency provides the information to an auditing tool according to the present disclosure, which is done electronically or remotely through a website or dedicated software user interface. The system then, in stages 103-105, automatically pulls (i.e., submits requests through a communication signal to a resource over the internet and receives a response) required information from various sources, assembles and aggregates that information into a user-interface dashboard, assesses the information in accordance with the applicable regulations, cross-checks the information provided to the information found on the available various sources, and determines whether the applicant is eligible and in compliance with the regulations. The regulations provide boundaries for comparison as it relates to specific jobs in specific locations that may vary depending on that location.

In stage 106, the auditing tool provides an audit of the retrieved information in the form of a compliance score at a pre-determined cadence requested by the staffing agency. Risk assessment and mitigation, according to the risk value of certain jobs, can also be assessed. The auditing tool can also regularly check existing employees for continued compliance according to a pre-determined cadence rate, such as drug screening, criminal background checks, and renewing of licenses. In a further example, the auditing tool is programmed to determine and alert the company when an employee is due for another check or screen according to regulations or protocol. In a further example, an alert is generated when a risk score exceeds a certain threshold for a particular employee and generates a flag to prevent that employee from further processing through human resources or continuing to work until the alert is resolved. The system can be configured to generate and communicate the alert to the system operator at a remote location, an immediate supervisor, an employee screening checkpoint and the employee themselves. The alert can be communicated through any electronic communications system like email or text messaging. In a further example, the alert is tied to the employee's badge that prevents scanning in to work.

As shown in FIG. 2, an auditing tool is utilized by aggregating data provided by the third-party staffing agency. The staffing agency provides the employee identity to the auditing tool, as shown in stage 201. The information is stored and organized in the auditing tool. In stage 203, the auditing tool connects to available sources for background checks and drug screens. The auditing tool then pulls the relevant information from these sources, organizes the information, and relays the information to the staffing agency via a dashboard, as shown in stages 204-206. An algorithm in the auditing tool generates an audit of the employee as it relates to his or her compliance with the required checks and screens according to the relevant regulations or protocols.

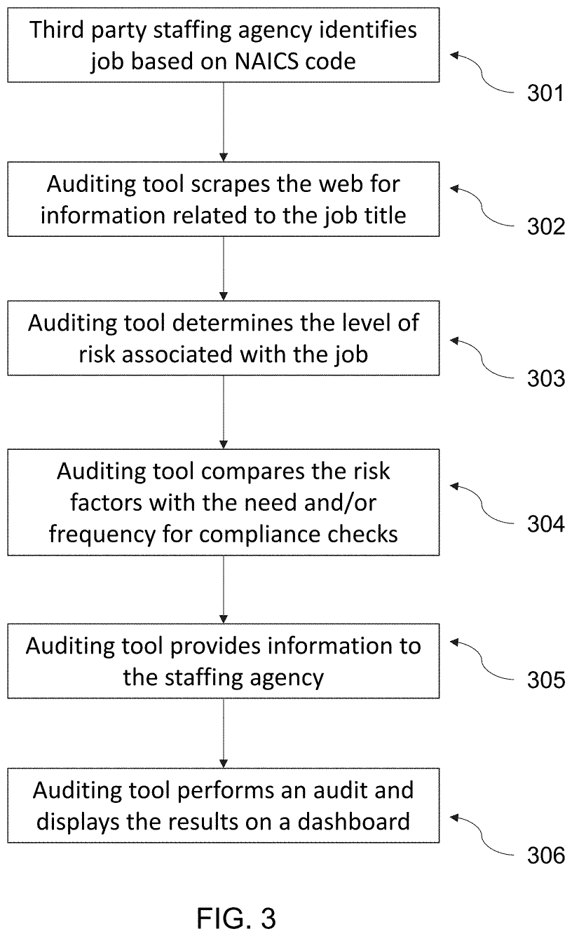

FIG. 3 illustrates a flow diagram of a risk assessment and auditing process based on the applicant's and/or employee's job title. An auditing tool is configured to identify a job description based on the North American Industry Classification System (“NAICS”), which is used by governing bodies across the United States, Mexico, and Canada, as shown in stage 301. In stage 302, the auditing tool scrapes the web, including from the Bureau of Labor Statistics and the Occupational Health and Safety Administration (“OHSA”) for information related to the job title to determine the risks associated with each job. This information contributes to establishing boundary conditions for comparison with specific individual's background information. For example, if an applicant is applying for an accounting position, the auditing tool will look to the Bureau of Labor Statistics and OHSA statistics regarding the level of danger associated with an accountant job. As an example, the tool will take into account frequency of workplace injuries associated with an accountant and take that into account when determining the risk. Further, the auditing tool will assess the risk of a certain applicant related to that job title. For example, studies have shown that an employee with a low credit score is more likely to embezzle money from a company as compared to an employee with a criminal background. The auditing tool then analyzes the risk associated with the job and compares it with information associated with the applicant. It then establishes a sampling frequency for monitoring compliance with each worker, as shown in stages 304-306. The auditing tool generates an audit of the employees as it relates to their compliance with the required checks and screens according to the relevant regulations or protocols. For example, the auditing tool may result in low risk and fewer sampling events for a custodial or landscaping position with a low credit score but increase the frequency for drug screening since substance abuse history may increase risk of injury for physically demanding jobs. For the accountant with a low credit score, a much more frequent sampling of their credit score and criminal background check may be required by the auditing tool.

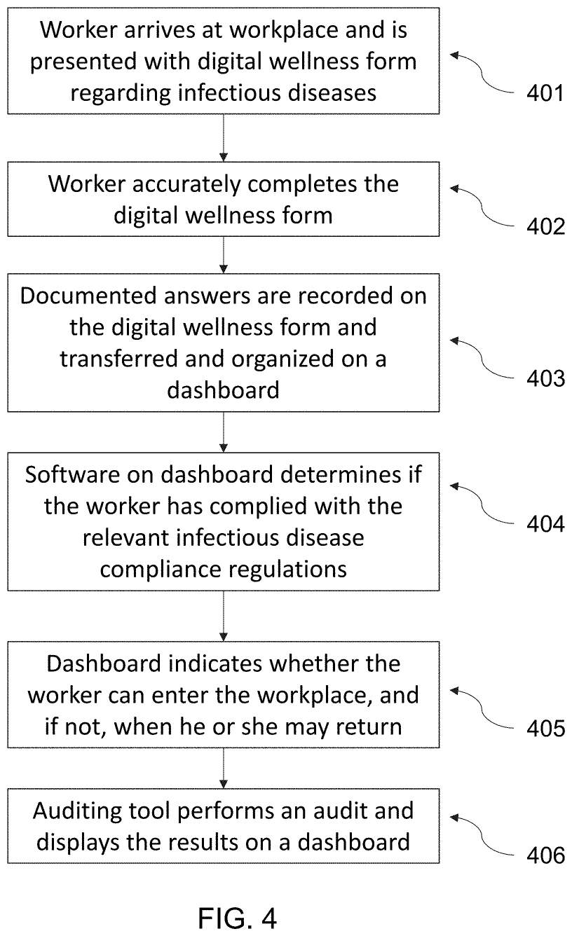

FIGS. 4-6 illustrates how the auditing tool can be used to monitor a company's or an individual employee's compliance with infectious disease regulations, such as Covid-19 screening. In today's changing work environment, companies must be vigilant and proactive in stemming the spread of infectious diseases. Certain regulations instituted by local, state or federal governments can require companies to institute safety protocols, including temperature checks, required use of personal protective equipment (“PPE”), such as masks or face shields, health and wellness screenings/questionnaires, cleanliness and disinfectant procedures and frequency, and contact tracing should any infection be reported.

FIG. 4 illustrates a digital wellness form and check system and process for monitoring and implementing compliance with the government regulations. In stage 401, when a worker arrives at work, the worker measures his or her body temperature and inputs that data into a digital wellness form, as shown in stage 402. In an example, a digital thermometer is used that communicates wirelessly with a device that hosts and displays the wellness form. The device is configured to store the information of the wellness form, assign it to the individual to generate a user specific data pack that can be communicated wirelessly to a remote server and aggregated a remote location for tracking of that worksite. The digital wellness form can be on a computer interface, tablet or mobile phone application. In another example, the digital wellness form is provided on a dedicated device for processing and communicating employee specific wellness information.

In an example, the worker will be prompted to populate answers to the other health-related questions, such as the use of PPE, exposure to others who have been sick, and experiencing of symptoms of disease. In stages 403-406, the results from the digital wellness form are then organized and communicated to a dashboard that is programmed to indicate the workers' compliance with the government regulations (i.e., compliance boundaries for a specific location) and indicate whether a worker is allowed to be onsite that day. The data packet for a specific employee can track their wellness compliance history and associate with that individual's employment badge or number.

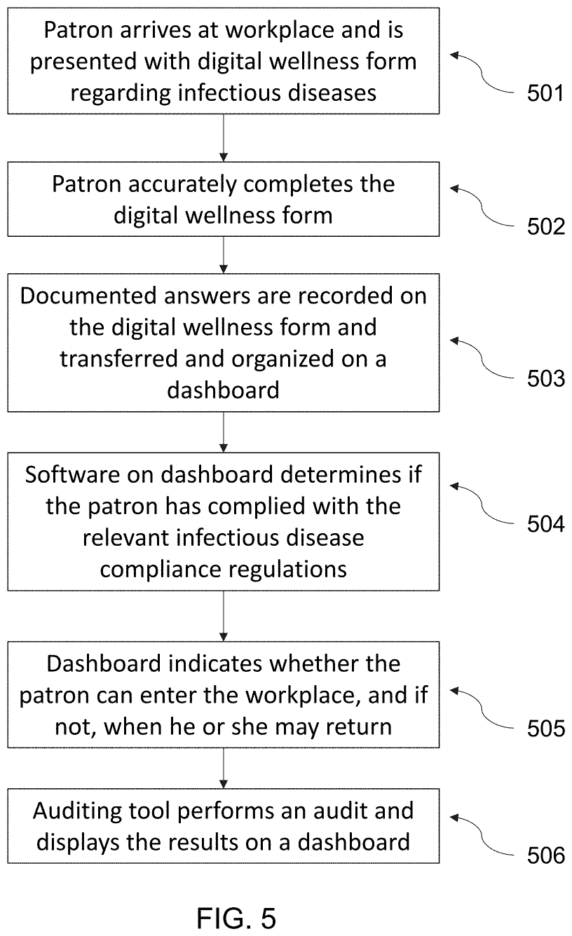

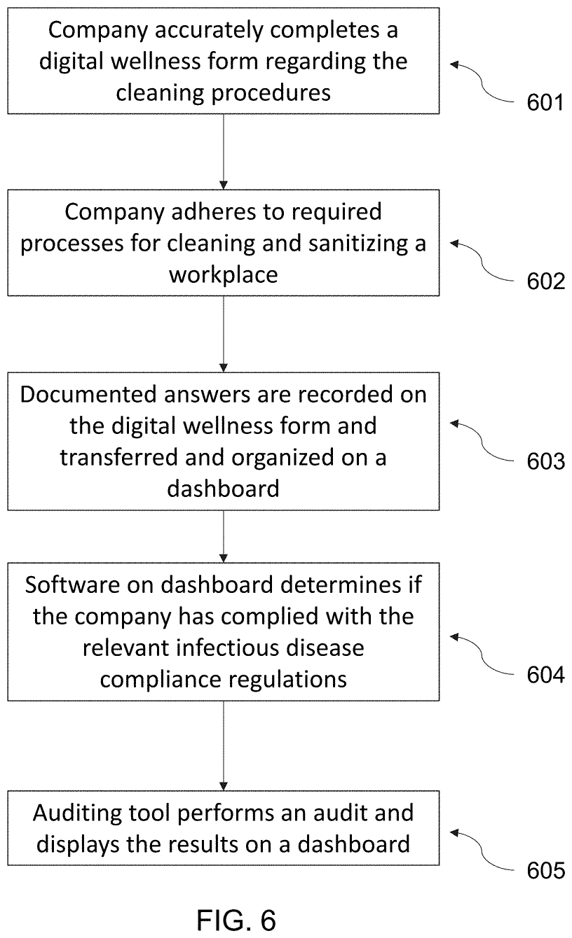

In a further example, as shown in FIG. 5, a similar wellness form and check system and process can be used on visitors, patrons or clients of a company that intend on entering the company premises. Certain waivers of potential liability of the company should an employee or patron become sick can be included within the wellness form. In yet a further example, as shown in FIG. 6, the wellness form and check system and process can be used by a company to track and monitor cleaning and disinfecting procedures at the workplace. The auditing tool generates an audit of the inputted data as it relates to the compliance with the required checks and screens according to the relevant regulations or protocols. Moreover, in even a further example, PPE inventory can be managed to trigger ordering and shipping of required PPE based on use and work conditions.

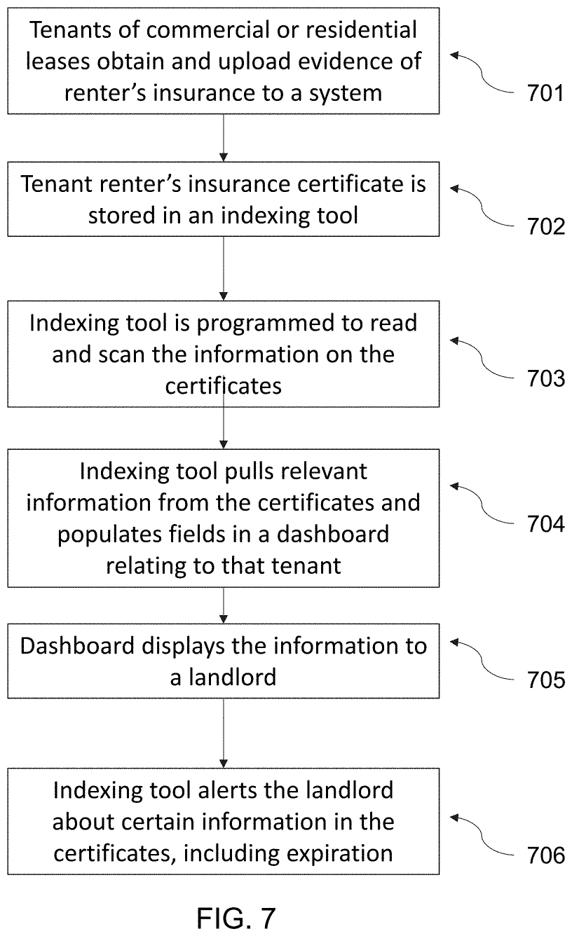

FIG. 7 illustrates a flow diagram for an indexing tool designed for landlords that organize and display information from a tenant's rental insurance certificate. In most leases for real estate or residential property, landlords and/or property management companies require that tenants obtain rental insurance as a condition to leasing. Often times, typically in large apartment complexes with many tenants, it is difficult for a landlord to be able to manage and ensure that every tenant has effective rental insurance. An indexing tool, as described in stage 702, allows landlords to easily manage and keep track of the tenant's renters' insurance. As described in stage 701, a tenant uploads a scan of a rental insurance certificate to a system of the present disclosure via a website or portal. The certificate is then stored and read by an indexing tool.

In stage 704, the indexing tool extracts information from the certificate, including the insurer, total amount of the policy, certain exclusions, and expiration date. This information is then stored on a dashboard as the indexing tool populates the relevant fields of a dashboard according to the information on the certificate. The indexing tool further compares the data obtained from the scanned policy to ensure that the policy complies with preset parameters. An alert is generated or the system prevents the tenant from submitting the scanned document if it does not comply with all preset requirements. This can include the name and signature of the lease holder, the correct address, a minimum coverage amount, and confirmation that it has not expired. This prevents, a tenant, for example, from uploading a non-compliant or false document to merely appease the requirement. The landlord can access the dashboard which shows the complying certificate information of each tenant. In stage 706, the indexing tool is programmed to generate automated alerts to the landlord and the tenant of any issues with the rental insurance certificate, including expiration of the certificate and/or renewal notices or warnings.

The system can further be evaluated on an enterprise level that allows a property management company to monitor each of its properties and gauge compliance statistics. They system can establish compliance parameters specific to each location or jurisdiction specific to each property thus significantly improving the monitoring and management of compliance, risk, and safety multiple properties. Properties with weaker compliance scores can be flagged as higher risk properties, thus requiring more supervision and attention.

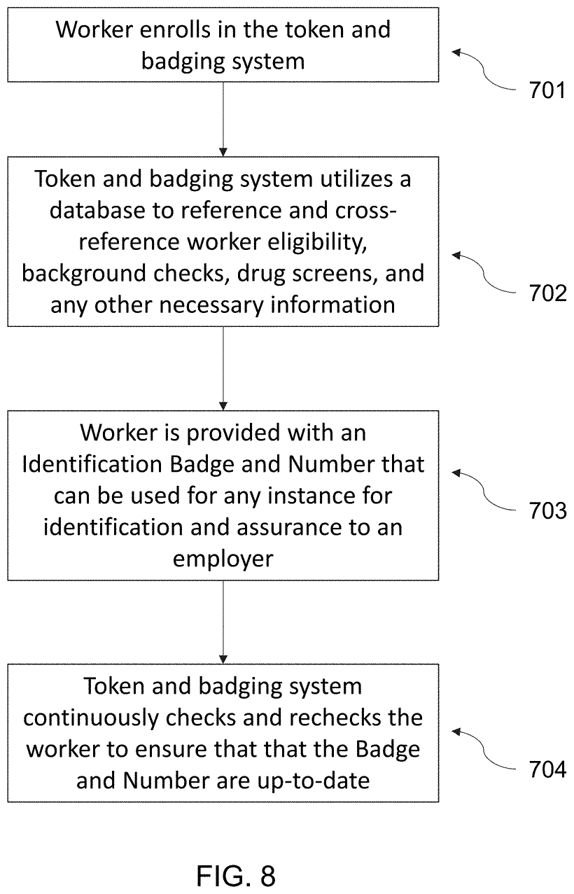

FIG. 8 illustrates a flow diagram of a token and badging system where employees are able to take current results of their own background check and credentialing with them as portable identification, which follows that individual from job to job. This effort is empowered by the worker initially submitting to a background check, a drug screen and a photograph. As shown in stage 801, a worker first enrolls in the token and badging system. Stage 802 shows that the token and badging system utilizes a database to reference and cross-reference worker eligibility, background checks, and drug screens. Stage 803 illustrates that when a worker completes all the necessary checks, the worker is provided with an Identification Badge and Number that is used as a portable credential with another employer. This allows the employee to take ownership of their situation and lessons the burden on the employer to continuously resubmit for this information. As shown in stage 804, the information is then reevaluated at a pre-determined frequency as desired or required. When a requesting party requests to retrieve the information, it can be viewed with any internet connected device, particularly if it is capable of scanning a QR code or other unique identifier. In an example, the badge associated with the individual can be a digital badge saved in an app on a phone or tablet or a physical card that includes a user specific QR code or identifier.

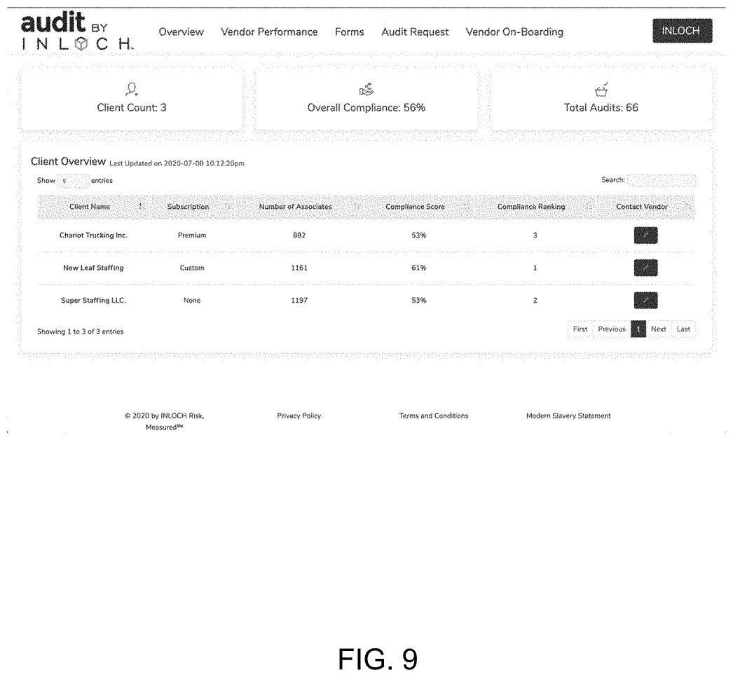

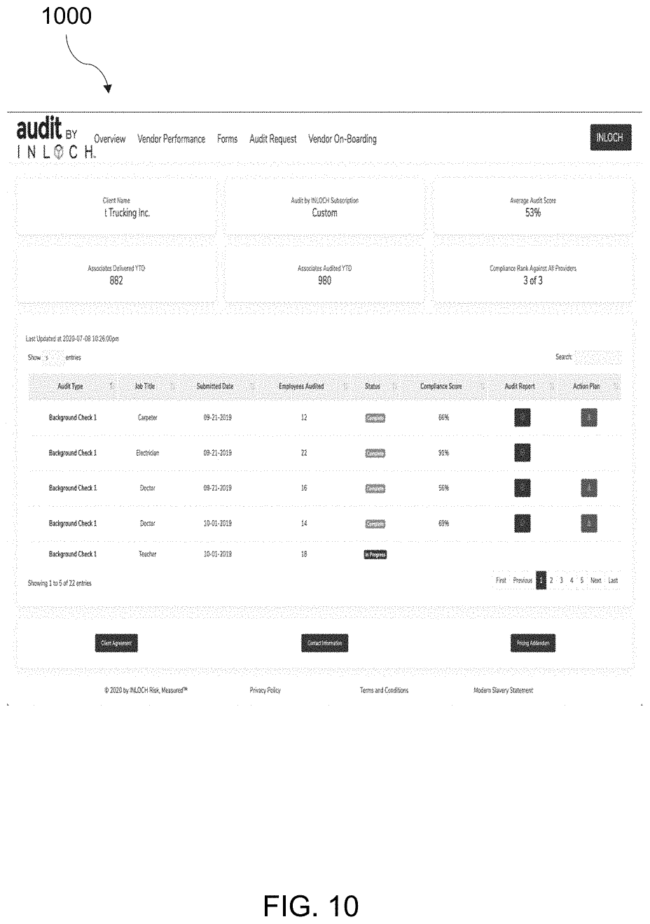

FIGS. 9-15 illustrate various schematics of a client-user interface employment compliance monitoring dashboard. FIG. 9 illustrates the overall layout of the employment compliance monitoring dashboard. In this example, the dashboard is configured to display information according to third-party staffing agencies, or “vendors”. Each vendor has auditing information according to that individual vendor, including a number of associates/employees, a compliance score in percentage format, and a compliance ranking in relation to other vendors. FIG. 10 illustrates a vendor performance dashboard 1000 whereby users can access auditing and compliance information. The vendor performance allows users to access the individual vendor's auditing and compliance information. In an example, audits are organized according the job title. Compliance scores and number of edits are tallied according to job description. The number of checks and screens required are determined according to the risk assessment of a particular job.

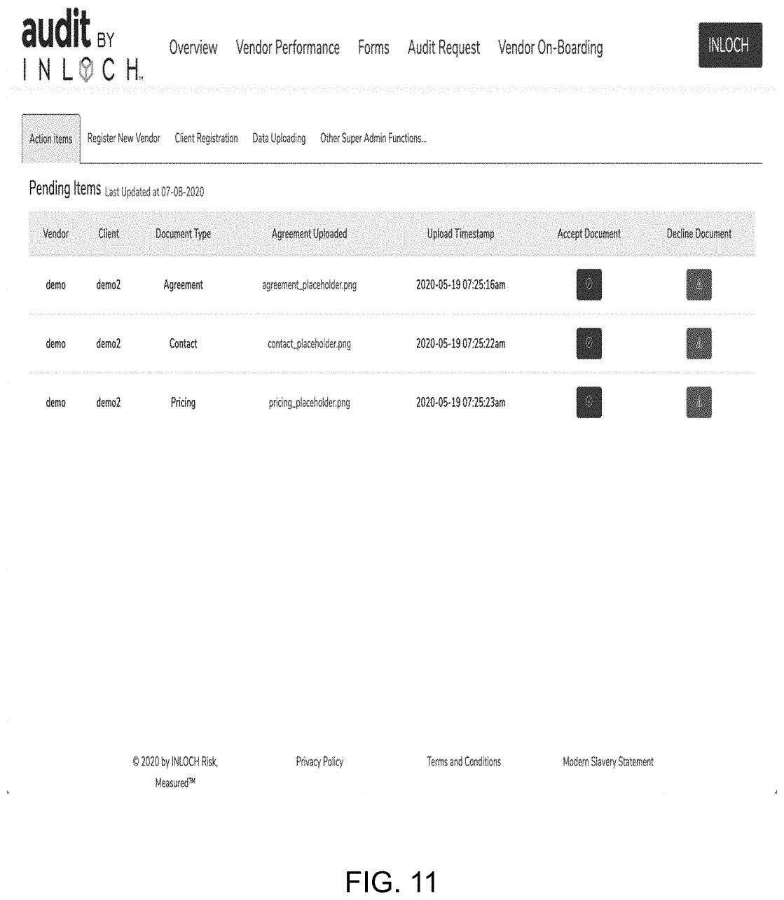

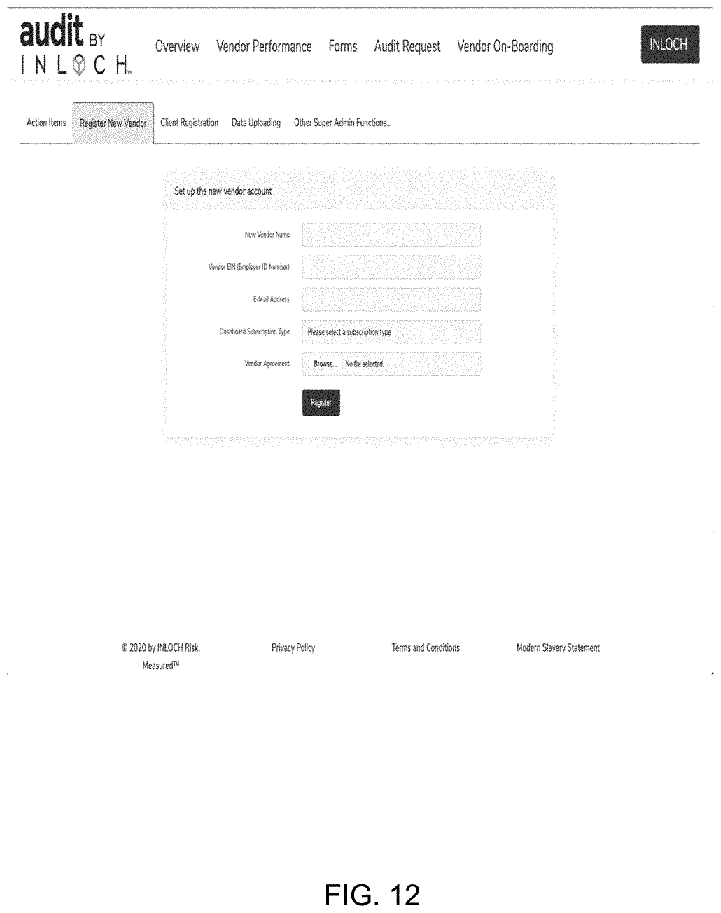

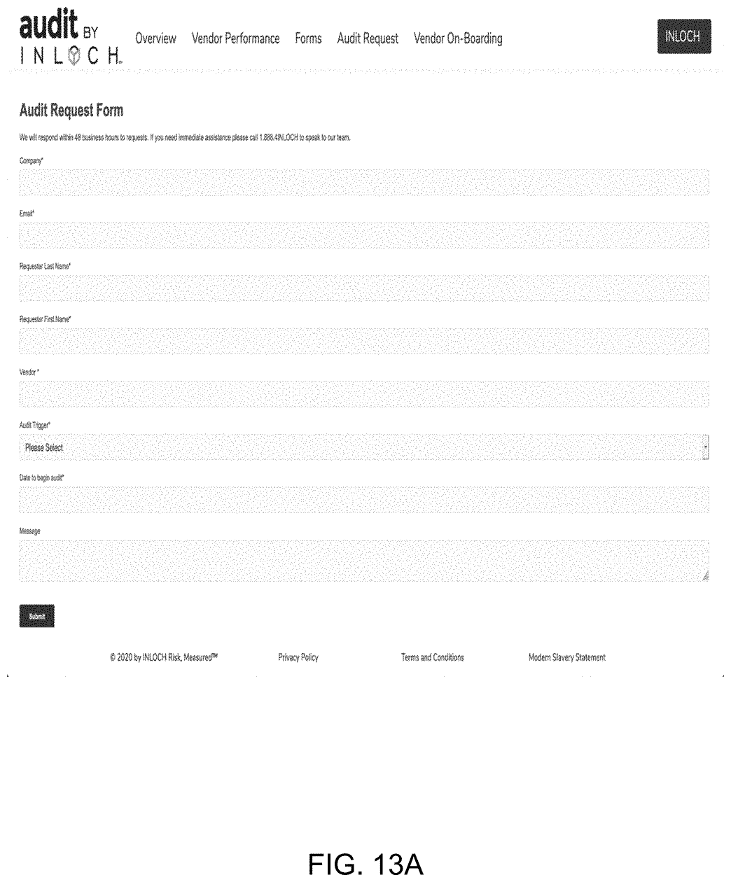

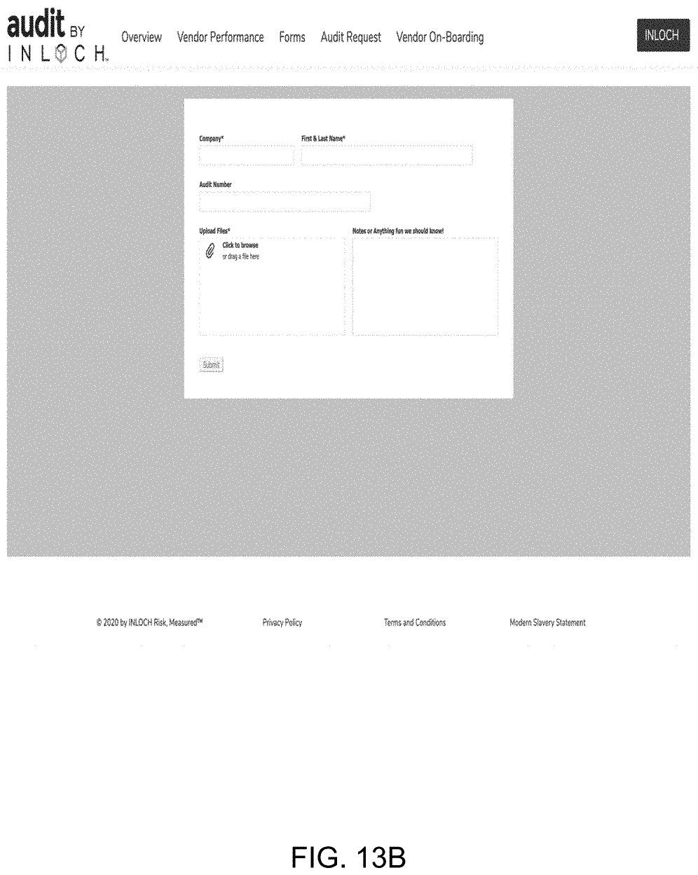

FIG. 11 illustrates a vendor on-boarding action items dashboard screen, whereby a particular agreement between a user and a vendor are uploaded and organized in the dashboard screen. The dashboard allows the user to either accept or decline the agreement directly through the dashboard. FIG. 12 illustrates a vendor on-boarding new vendor dashboard screen that allows the user to register and set up a new vendor to be included on the user's auditing information. The user can directly upload the agreement between the user and the vendor. This will allow the auditing tool to perform audits on the vendor's employees or workers to determine their compliance and risk scores. FIGS. 13A and 13B illustrate various audit request actions. FIG. 13A illustrates an audit request form whereby the user completes the information on the form, which then prompts the auditing tool to gather data and complete an audit of compliance with regulations of that specific vendor. In another example and shown in FIG. 13B, the user can directly upload data of compliance with regulations, and the auditing tool will determine and produce a compliance score for that specific vendor. The auditing tool is configured to automatically obtain compliance requirements for a specific job and related to a specific location (i.e., a municipality or state specific information). This information is incorporated into the dashboard and establishes compliance boundaries or evaluating employees.

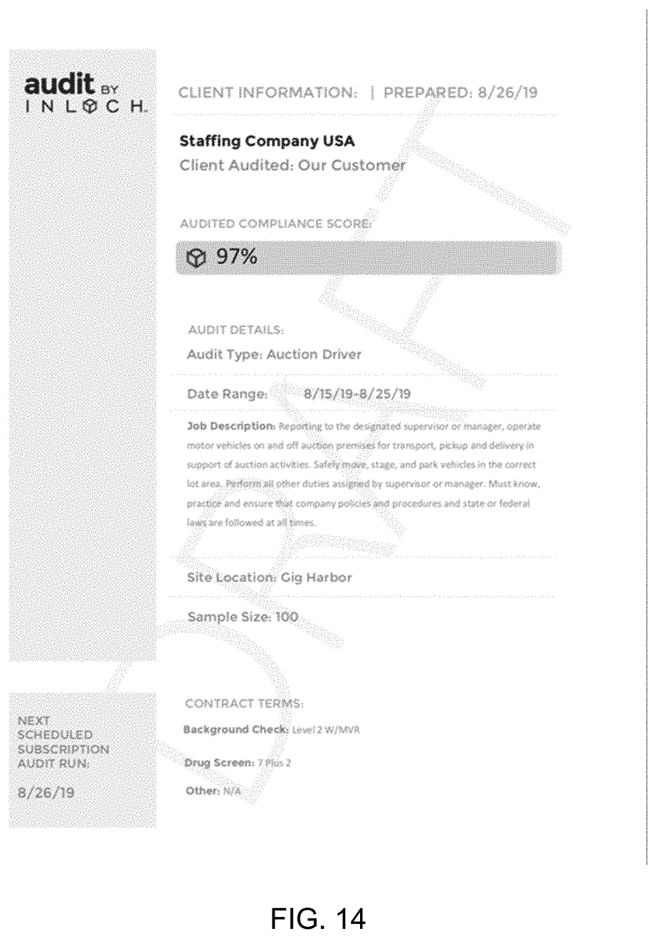

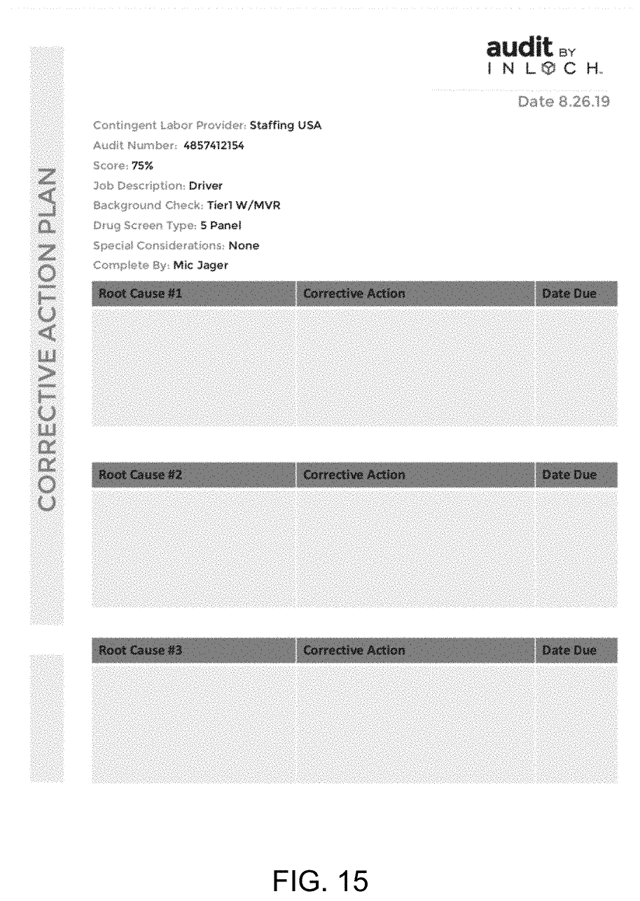

FIG. 14 illustrates a compliance report page for a specific vendor. The compliance report page is compiled and generated after the auditing tool completes a compliance audit for the specific vendor. The compliance report determines the vendor's employees/workers compliance with certain government regulations as it relates to items such as background checks and drug screens. The required checks are determined based on the algorithmic determination of risk based on the certain job description of the employee/worker. The compliance report page gives the user an audited compliance score, which is a percentage score representing the percentage of employees/workers that met the required checks and screens according to the job description. FIG. 15 illustrates a corrective action plan that is generated by either the vendor or the auditing tool. The corrective action plan is a remedial measure used to rectify the vendor's noncompliance with certain government regulations. Following of the corrective action plan will mitigate both the vendor's and the company's risks associated with the employees.

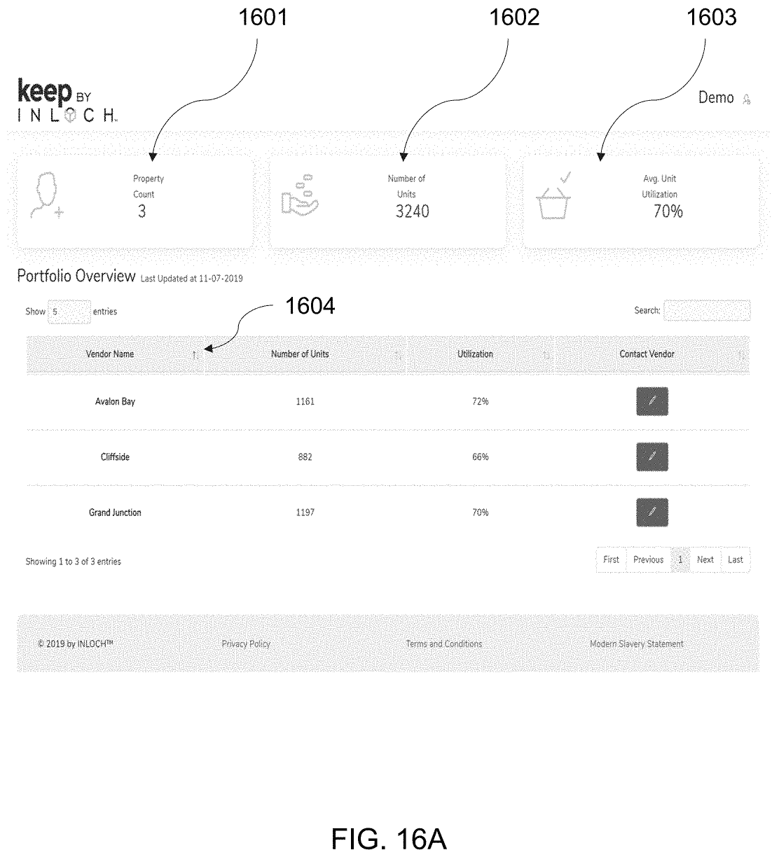

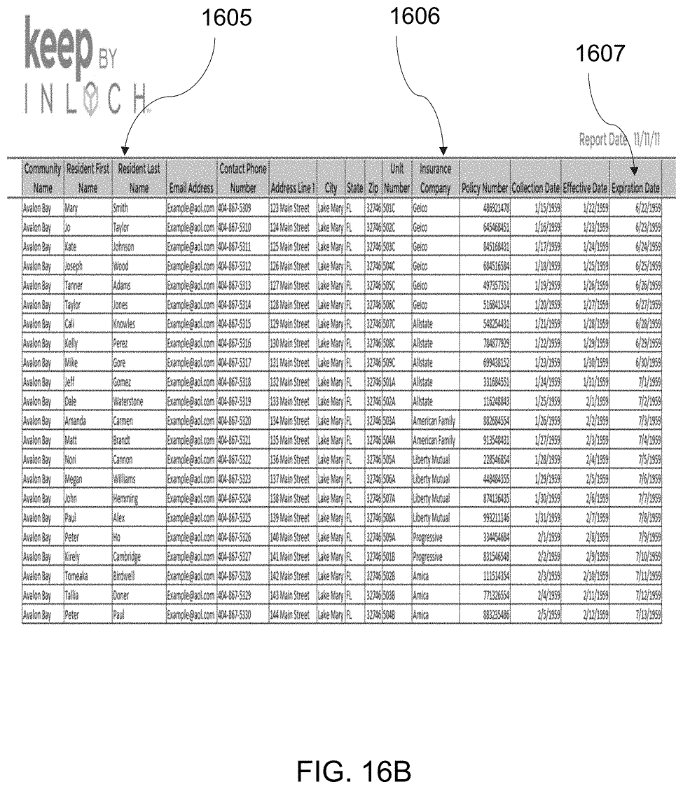

FIGS. 16A and 16B display a client-user interface rental insurance monitoring dashboard for landlords to monitor and organize a tenant's required use of rental insurance. In most leases for real estate or residential property, landlords require that tenants obtain rental insurance as a condition to leasing. Often times, especially in large complexes with many tenants, it is difficult for a landlord to be able to manage and ensure that every tenant has up-to-date rental insurance. FIG. 16A illustrates a landlord home page. Icon 1601 indicates to the landlord a total number of properties being monitored on the interface. Icon 1602 indicates a total number of units being monitored on the interface. Icon 1603 indicates a total percentage of compliance by tenants with the required rental insurance policy. Sub-dashboard 1604 breaks down the number of units and percentage of compliance by the specific vendor or property. FIG. 16B illustrates a populated data sheet for each individual tenant. The data sheet is populated through an algorithm which takes PDFs or screenshots of the rental insurance certificates and automatically transfers the information in those certificates to the correct field. In an example, icon 1605 indicates a tenant's name, icon 1606 indicates an insurance company, and icon 1607 indicates an expiration date of the policy. The system and process is designed to alert the landlord or user on the client-user interface if any of the tenant's rental insurance certificates have expired or if the scanned document is not in compliance with standards.

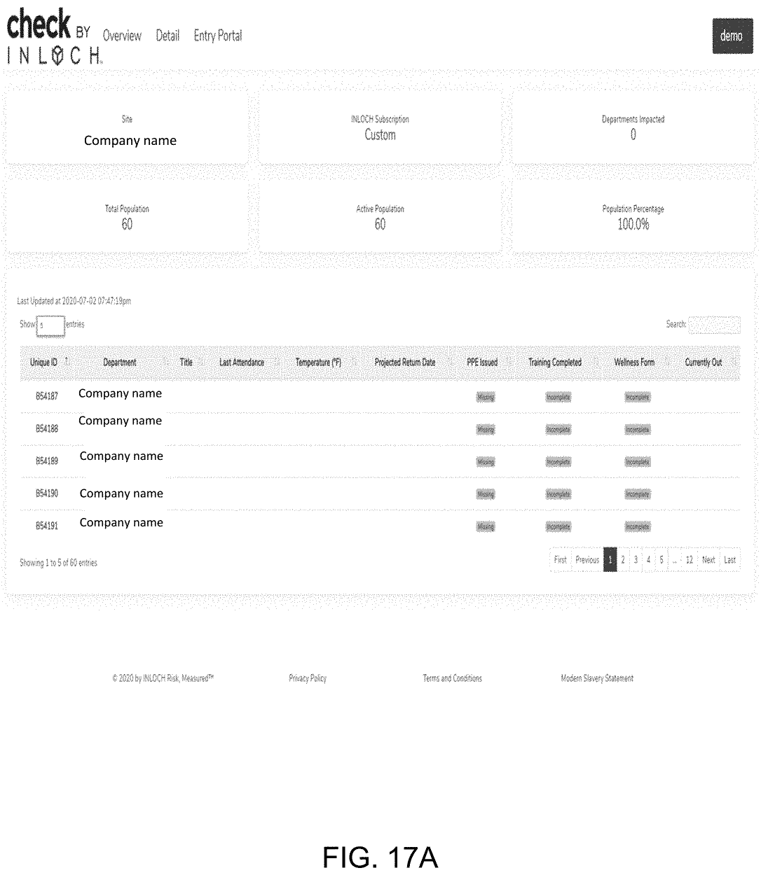

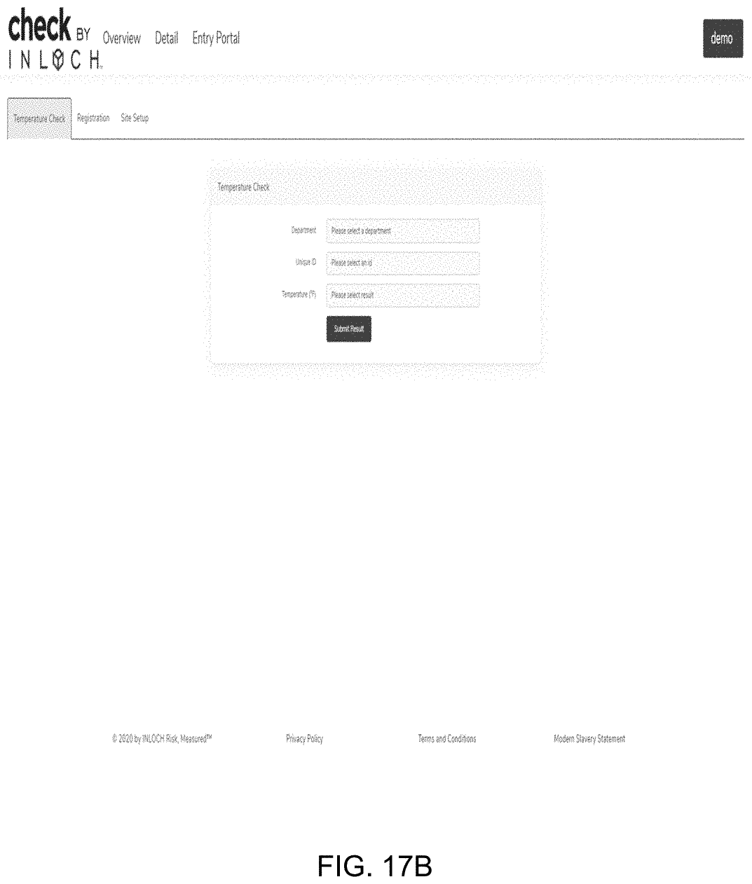

FIGS. 17A and 17B illustrate schematic views of a client user interface infectious disease dashboard which aggregates and displays compliance with infectious disease regulations and requirements. As shown in FIG. 17A, the infectious disease dashboard is organized according to a company. The company's employees are required to complete certain infectious disease requirements, such as temperate checks, required use of personal protective equipment, required training, and completion of wellness screenings and forms. Each employee is assigned a unique identification number. The dashboard provides the user company with a compiled, detailed view of all the employee's compliance with the infectious disease requirements and alerts the user company if any of the employees have failed to comply with the requirements. FIG. 17B illustrates an example infectious disease requirement in the form of a temperature check where an employee must fill out the information in order to enter the workplace premises. In this example, the employee must enter his or her department, user identification number, and body temperature verified onsite by digital thermometer. This information is then communicated and tracked to the infectious disease dashboard for the company to easily view, track, and regulate.

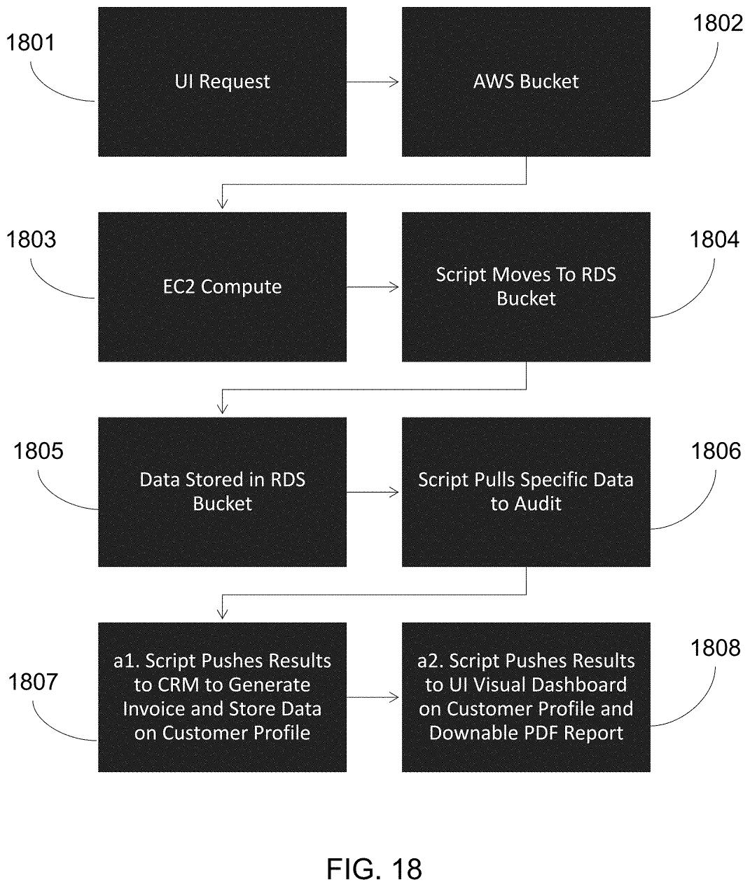

FIG. 18 illustrates a flow diagram of an auditing program designed to monitor compliance and risk assessment and display the results on a visual dashboard. The auditing program of the present disclosure can be automated or initiated upon a user's request at a user interface as described in stage 1801. The request is moved to an Amazon Web Services (“AWS”) bucket, which is then secured and resized in an Elastic Compute Cloud (“EC2”) as shown in stages 1802 and 1803. The request with an accompanying algorithm then moves to a Relational Database Service (“RDS”) bucket, shown in stage 1804. The algorithm pulls data from various, pre-determined disparate sources on the web and stores the data in the RDS bucket. As shown in Stage 1806-1808, the system and process pulls specific data from the RDS bucket and performs an audit based on pre-determined criteria and boundaries and pushes it to a Customer Relationship Management (“CRM”) portal to be reviewed and stored. In another example, the process pushes the data to a user interface, i.e. a visual dashboard, so that the user can review the audit report. Alerts can be established to generate when compliance boundaries are breached or thresholds are reached. Those alerts can trigger automated blocking of employees' badges from entering a premise, for example, or flag a human resources department to prevent advancement of the individual in a hiring process until a condition is satisfied.

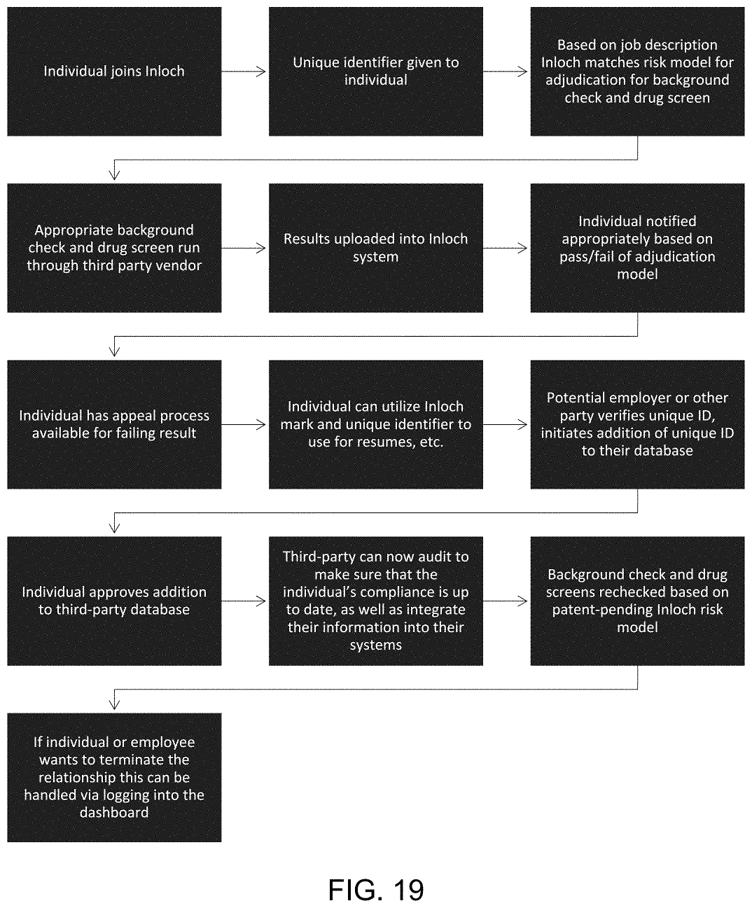

FIG. 19 illustrates a flow diagram of a token and badging system and process whereby employees are able to take the results from their own background check and credentialing as a portable identification tool. When an individual employee joins the system, the system generates a unique identifier for the individual. The system's algorithm recognizes the job description and risk assessment model for that certain job and determines the required background checks and screens required for that individual employee. The risk assessment model determines the number of checks required based on the unique risk associated with each job and required government regulations. The risk assessment model pulls information from various job sources indicating various risks associated with the job, including the likelihood of workplace injuries and potential for fraud or theft. The individual employee then undergoes the required checks and uploads the information from the checks into the system. The system reads and processes the information and determines if the individual has passed or failed the risk assessment model. An individual who fails can appeal that decision. An individual who passes the checks receives a unique Identification Badge and Number, indicating to current or potential employers the passing of the background check. Any potential employer can then use that individual employee's Identification Badge and Number to ensure that the individual has the mandatory checks required for the job and also perform an audit on the individual to make sure that the individual's compliance is up to date. The information from those checks can also be uploaded on to the employer's system and a further risk assessment check can be performed on the individual.

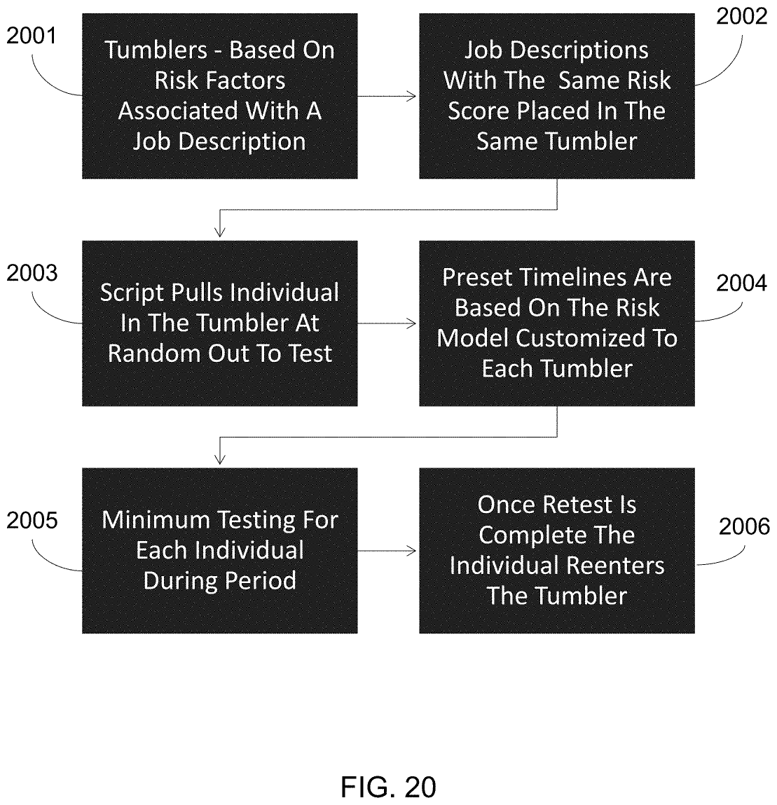

FIG. 20 illustrates a flow diagram of a tumbler model that measures compliance monitoring across various jobs with similar risk assessment. As shown in stage 2001, a tumbler is determined by set of risk factors that are associated with a certain job description. Individual employees with jobs that have a similar risk assessment are placed in the same tumbler, as shown in stage 2002. For example, a building custodian and a hotel cleaning personnel might have similar risks associated with each job; while an accountant and a construction worker might have very different risks associated with each job. Risks associated to the individual employee can be the potential workplace injuries to the employee. Risks associated to the employer could be potential theft of employer property, risk of injury, or fraud to the employer. In stage 2003, the system randomly selects an individual employee from the tumbler to determine if that employee has undergone the required checks for compliance monitoring, such as background checks and drug screens. In an example, the system also determines whether that individual is up to date on all of the required checks. The frequency of the random testing is directly related to the risk associated with the tumbler, i.e. the higher the risk, the more frequent the testing. As shown in stage 2005, the algorithm is programmed so that each individual employee will be tested at some point in a pre-determined period. Once the individual is tested for compliance, the individual is placed back in the tumbler and the cycle repeats for a given period of time.

It should be noted that the steps described in the process of use can be carried out in many different orders according to user preference. The use of “step of” should not be interpreted as “step for”, in the claims herein and is not intended to invoke the provisions of 35 U.S.C. § 112 (f). Upon reading this specification, it should be appreciated that, under appropriate circumstances, considering such issues as design preference, user preferences, marketing preferences, cost, structural requirements, available materials, technological advances, etc., other processes of use arrangements such as, for example, different orders within above-mentioned list, elimination or addition of certain steps, including or excluding certain maintenance steps, etc., may be sufficient.

What is claimed is:

1. A safety compliance and auditing process comprising the steps of:
providing a computer-generated program accessible by a computer device having a processer, a user interface visual display for hosting a dashboard, a wireless communication module, and a storage unit, the program is configured to perform an audit process through the steps of
(a) requesting and receiving compliance information from a plurality of safety compliance sources accessible through an internet connection;
(b) establishing compliance boundaries based on the obtained compliance information from the safety compliance sources corresponding to a specific job and location;
(c) requesting background information associated to an individual from a plurality of background information sources available through the internet connection;
(d) comparing the background information to the compliance boundaries to determine if the background information surpasses a boundary;
(e) generating an alert if the background information surpasses a boundary indicating a non-compliant background check for the individual;
(f) generating a risk score associated with the individual based on the compliance information, the specific job, and location; and
(g) initiating a sampling frequency to trigger a repeat audit corresponding to the risk score.

2. The process of claim 1, wherein the computer program is hosted and the process steps are executed on a cloud computing storage system.

3. The process of claim 2, wherein the cloud storage is configured to transfer and store the compliance and background information through a relational database and wherein, the relational database is configured to transfer the information to the dashboard to be displayed for a user to read and interpret; and wherein, the dashboard is configured to process and read the information and create alerts and notifications based on the information collected when risk scores surpass preset thresholds associated with a specific job, location, and compliance requirements.

4. The process according to claim 1, wherein the compliance information is employment compliance information and the background information includes criminal background checks, employment eligibility, and drug screening for existing or potential employees.

5. The process according to claim 1, wherein the alerts are generated by an internal auditing tool that measures compliance of the employment compliance information to governmental employment regulations.

6. The process according to claim 5, wherein the alerts are generated by the internal auditing tool that measures risk assessment of an employee or potential employee based on the employment compliance information and an existing job position or applied-for job position.

7. The process according to claim 1, wherein the program is configured to automatically gather compliance information on a preset sample frequency to ensure the boundaries are updated.

8. The process according to claim 1, wherein the program determines a required number of background checks and drug screens depending on the job title and wherein the individual receives a unique identification number when passing the required number of checks and screens.

9. The process according to claim 1, wherein sampling frequency is modified in response to tracking of alerts to modify the risk score.

10. The process according to claim 1, wherein the alert automatically prevents an employee processing program from advancing to a next step until the alert is removed.

11. The process according to claim 1, wherein the alert is generating for an existing employee having a badge for entry to a worksite or premise, and the badge is flagged to prevent accessibility to the worksite or premise until the alert is removed.

12. An employment compliance management system comprising:
(a) an auditing tool provided on a computer and hosted locally or remotely accessibly by a dedicated computer or tablet;
(b) an automated dashboard provided in the tool, the tool configured to aggregate and audit data related to background check information for employees;
(c) background check data accessibly by the tool and obtained through an internet connection from a plurality of automated background check sources; and
(d) a user interface for displaying the dashboard that allows auditing of the background check data and generating a risk factor and compliance score associated with the background check data.
